(19) United States
(12) Patent Application Publication
(10) Pub. No.: US 2025/0389404 A1
(43) Pub. Date: Dec. 25, 2025

(54) VEHICLE EXTERIOR COMPONENT AND VEHICLE ILLUMINATION UNIT

(71) Applicant: FALTEC Co. Ltd., Kawasaki-shi (JP)

(72) Inventors: Koshiro OTA, Yokohama-shi (JP); Yuki YOSHIDA, Iwaki-shi (JP)

(21) Appl. No.: 19/243,203

(22) Filed: Jun. 19, 2025

(30) Foreign Application Priority Data
Jun. 20, 2024 (JP) 2024-099618

(51) Int. Cl. F21S 43/20; F21S 41/20; F21S 41/64

(52) U.S. Cl. CPC F21S 43/2817; F21S 41/285; F21S 41/64

(57) ABSTRACT

A vehicle exterior component includes: a plate-shaped base material having translucency that visible light is transmitted therethrough; a front surface coating film covering a front surface of the base material directed to front; and a light-absorbing film provided on a rear surface of the base material directed to rear and including an opening portion exposing at least part of the rear surface. The rear surface of the base material includes: an adhesion surface to which the light-absorbing film is adhered, and an exposed surface exposed through the opening portion. The exposed surface is rougher than the adhesion surface.

Priority is claimed on Japanese Patent Application No. 2024-099618, filed Jun. 20, 2024, the content of which is incorporated herein by reference.

### BACKGROUND OF THE INVENTION

### Field of the Invention

The present invention relates to a vehicle exterior component and a vehicle illumination unit.

### Description of Related Art

Various exterior components (vehicle exterior components) are mounted on a vehicle. These vehicle exterior components are components that are visible from the outside of the vehicle and have a significant impact on the formation of the vehicle's appearance impression.

For example, Japanese Unexamined Patent Application, First Publication No. 2003-081034 (hereinafter, referred to as Patent Document 1) discloses a front grill to be provided in a vehicle. The front grill disclosed in Patent Document 1 is provided in the front of the vehicle.

Not only the front grill disclosed in Patent Document 1 but the vehicle exterior component is attached to a position visible from the outside and is irradiated with direct sunlight during the daytime. On the other hand, the vehicle exterior component is not irradiated with direct sunlight at night or the like. Therefore, the vehicle exterior component is illuminated by transmitting visible light therethrough while not being irradiated with direct sunlight, for example. In this case, a pattern or character may be shown on the front surface of the vehicle exterior component by patterning a region through which the illumination light is transmitted. The vehicle exterior component may be required that a person outside more clearly visually recognize such a pattern or character.

The present invention was made in view of the above-described problems, and an object thereof is to provide a vehicle exterior component that allows a person outside to more clearly visually recognize a pattern or character displayed by transmitting illumination light therethrough, and a vehicle illumination unit including it.

### SUMMARY OF THE INVENTION

The present invention adopts the following configurations as means for solving the above problems.

A vehicle exterior component according to a first aspect of the present invention includes: a plate-shaped base material having translucency that visible light is transmitted therethrough; a front surface coating film covering a front surface of the base material directed to front; and a light-absorbing layer provided on a rear surface of the base material directed to rear and including an opening portion exposing at least part of the rear surface, in which the rear surface of the base material includes an adhesion surface to which the light-absorbing layer is adhered, and an exposed surface exposed through the opening portion, and the exposed surface is rougher than the adhesion surface.

A vehicle exterior component according to a second aspect of the present invention is that the vehicle exterior component of the first aspect includes: when illumination light is applied to the base material from the rear, a dark region visually recognized from the front, and a bright region visually recognized to be brighter than the dark region from the front, in which the opening portion is disposed to overlap the bright region when viewed from the front.

A vehicle exterior component according to a third aspect of the present invention is that the vehicle exterior component of the second aspect includes: a transmittance-adjusting member provided on the rear surface of the base material in the bright region and adjusting a transmittance of the light-absorbing layer in the bright region.

A vehicle exterior component according to a fourth aspect of the present invention is that the vehicle exterior component of the third aspect includes: a plurality of the bright regions having different transmittances of the light-absorbing layer.

A vehicle exterior component according to a fifth aspect of the present invention is that in the third or fourth aspect, the transmittance-adjusting member is formed of a same material as the light-absorbing layer.

A vehicle exterior component according to a sixth aspect of the present invention is that in any one of the first to fifth aspects, the light-absorbing layer is formed of a coating film obtained by drying paint.

A vehicle exterior component according to a seventh aspect of the present invention is that in any one of the first to sixth aspects, the light-absorbing layer is black with a lower brightness than the front surface coating film.

A vehicle exterior component according to an eighth aspect of the present invention is that the vehicle exterior component of any one of the first to seventh aspects includes: a transparent protective film covering the front surface coating film from the front.

A vehicle illumination unit according to a ninth aspect of the present invention includes: the vehicle exterior component according to any one of the first to eighth aspects; and an illumination device disposed on a rear side of the vehicle exterior component and configured to apply illumination light to the vehicle exterior component.

According to the present invention, the front surface of the base material is covered with the front surface coating film. When such a vehicle exterior component is irradiated with sunlight, the sunlight is reflected by the front surface coating film, and the entire vehicle exterior component is visually recognized in the color of the front surface coating film from the outside. In addition, when the vehicle exterior component is irradiated with illumination light, which is visible light, from the rear, the illumination light is transmitted to the front through the opening portion of the light-absorbing layer. Therefore, for example, in a place where sunlight does not shine, the region where the opening portion of the light-absorbing layer is provided is brightly visually recognized from the outside by applying illumination light and is visually recognized as a pattern or character by a person outside. In this case, according to the present invention, since the exposed surface of the rear surface of the base material is rougher than the adhesion surface to which the light-absorbing layer is adhered, light transmitted through the opening portion of the light-absorbing layer is scattered, and the brightness of a region that is visually recognized as bright can be made even. Furthermore, since the adhesion surface is smoother than the exposed surface, external light having entered the vehicle exterior component from the outside is limited from scattering at the adhesion surface and is easily absorbed by the light-absorbing layer. Therefore, according to the present invention, the boundary between the bright region and the dark region is clear, and a pattern or character displayed by transmitting the illumination light can be more clearly visually recognized by a person outside.

### BRIEF DESCRIPTION OF THE DRAWINGS

FIG. 1 is a schematic front view of a vehicle exterior component according to a first embodiment of the present invention.

FIG. 2 is a schematic cross-sectional view of the vehicle exterior component according to the first embodiment of the present invention.

FIG. 3 is a schematic cross-sectional view of a vehicle exterior component according to a second embodiment of the present invention.

FIG. 4 is a schematic cross-sectional view of a vehicle exterior component according to a third embodiment of the present invention.

FIG. 5 is a schematic cross-sectional view of a vehicle exterior component according to a fourth embodiment of the present invention.

### DETAILED DESCRIPTION OF THE EMBODIMENTS

Hereinafter, an embodiment of a vehicle exterior component according to the present invention will be described with reference to the drawings.

### First Embodiment

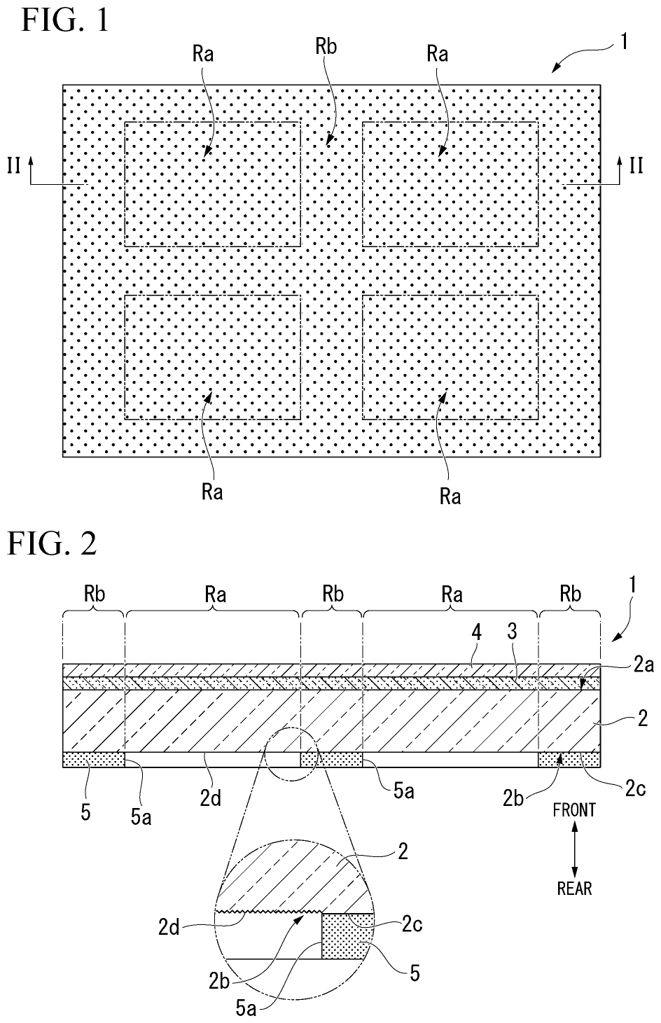

FIG. 1 is a schematic front view of a vehicle exterior component 1 of the present embodiment. In addition, FIG. 2 is a schematic cross-sectional view of the vehicle exterior component 1 of the present embodiment and corresponds to a cross-sectional view taken along the line II-II of FIG. 1. The vehicle exterior component 1 of the present embodiment is a component that is installed in a vehicle and is disposed at a position visible from the outside of the vehicle.

For example, as shown in FIG. 2, the vehicle exterior component 1 of the present embodiment includes a base material 2, a front surface coating film 3, a protective film 4, and a light-absorbing film 5 (light-absorbing layer). In the present embodiment, the base material 2 is formed in a plate shape. The base material 2 is disposed such that a surface on the front side (hereinafter, referred to as a front surface 2a) faces the outside of the vehicle and a surface on the rear side (hereinafter, referred to as a rear surface 2b) faces the inside of the vehicle. The shape of the base material 2 is not limited to a plate shape.

The installation posture of the vehicle exterior component 1 of the present embodiment is not particularly limited. However, for convenience of description, a side that the front surface 2a of the base material 2 faces is referred to as a front side, and a side that the rear surface 2b of the base material 2 faces is referred to as a rear side. The front-rear direction of the vehicle exterior component 1 of the present embodiment may coincide with or may not coincide with the direction of the vehicle. That is, the front-rear direction of the vehicle exterior component 1 of the present embodiment may coincide with or may not coincide with the front-rear direction of the vehicle.

The base material 2 is formed of a resin. In addition, in the present embodiment, the base material 2 has translucency that visible light is transmitted therethrough. That is, in the present embodiment, the base material 2 is formed of a transparent resin material. For example, the base material 2 can be formed of a polycarbonate resin or an acrylic resin. For example, the base material 2 is colorless and transparent. However, the base material 2 does not necessarily have to be colorless and transparent, and may be colored transparent. As described above, the base material 2 is a plate-shaped member having translucency that visible light is transmitted therethrough.

The front surface coating film 3 is a film formed by drying paint and is formed to cover the front surface 2a of the base material 2. For example, the front surface coating film 3 has a body color of a vehicle in which the vehicle exterior component 1 of the present embodiment is installed. The front surface coating film 3 is formed to cover the entire front surface 2a of the base material 2. The front surface coating film 3 is not limited to a single layer. For example, the front surface coating film 3 may be formed by laminating a plurality of layers. The front surface coating film 3 is formed to have a thickness through which part of visible light can be transmitted.

The protective film 4 is a transparent coating film formed to cover the front surface coating film 3 from the front. The protective film 4 limits the front surface coating film 3 from coming into contact with air or moisture and limits the front surface coating film 3 from deteriorating. However, if the front surface coating film 3 has high atmospheric corrosion resistance and the progress of deterioration thereof is slow, the protective film 4 may not be provided.

The light-absorbing film 5 is provided on the rear surface 2b of the base material 2. The light-absorbing film 5 is a light-shielding film that absorbs visible light to prevent visible light from transmitting therethrough. The light-absorbing film 5 is formed of, for example, a coating film containing a black pigment. The light-absorbing film 5 can be formed by applying paint containing a black pigment and then drying the paint. The light-absorbing film 5 is formed in black with a lower brightness than the front surface coating film 3.

However, the light-absorbing film 5 is not limited to a coating film, and may be a printed film formed by printing. In such a case, the light-absorbing film 5 can be formed by disposing a printing material on the rear surface 2b of the base material 2 by a printing method and then drying the printing material. In addition, the light-absorbing film 5 can also be formed of a film. In this case, the light-absorbing film 5 can be formed by attaching a pre-formed film to the rear surface 2b of the base material 2.

As shown in FIG. 2, the light-absorbing film 5 includes an opening portion 5a that exposes part of the rear surface 2b of the base material 2. A plurality of the opening portions 5a are provided in the light-absorbing film 5. Each opening portion 5a is formed to penetrate the light-absorbing film 5 in the front-rear direction. In the present embodiment, each opening portion 5a is formed to have a rectangular shape as viewed from the front. However, the shape of the opening portion 5a is not limited.

As shown in FIG. 2, the light-absorbing film 5 provided with the opening portions 5a is formed on the rear surface 2b of the base material 2. Therefore, the rear surface 2b of the base material 2 includes an adhesion surface 2c to which the light-absorbing film 5 is adhered and an exposed surface 2d exposed through the opening portion 5a. That is, the adhesion surface 2c of the base material 2 is a surface of the rear surface 2b of the base material 2 that is in contact with the light-absorbing film 5. In addition, the exposed surface 2d of the base material 2 is a surface of the rear surface 2b of the base material 2 that is not in contact with the light-absorbing film 5.

As shown in the enlarged view of FIG. 2, the exposed surface 2d is rougher than the adhesion surface 2c. That is, the exposed surface 2d is a surface formed to be rougher than the adhesion surface 2c. Here, the expression that the exposed surface 2d is rougher than the adhesion surface 2c means, for example, that a numerical value indicating the arithmetic average roughness of the exposed surface 2d is greater than a numerical value indicating the arithmetic average roughness of the adhesion surface 2c. When the exposed surface 2d is rougher than the adhesion surface 2c, the adhesion surface 2c is a smoother surface than the exposed surface 2d.

As shown in FIG. 1, the vehicle exterior component 1 of the present embodiment includes a bright region Ra and a dark region Rb as viewed from the front. The bright region Ra is a region that is visually recognized as bright from the front when illumination light is applied to the base material 2 from the rear. In addition, the dark region Rb is a region that is visually recognized as dark from the front when illumination light is applied to the base material 2 from the rear. The bright region Ra is visually recognized to be brighter than the dark region Rb from the front when illumination light is applied to the base material 2 from the rear.

The bright region Ra is a region where, when the base material 2 is illuminated from the rear, the illumination light passes through the opening portion 5a of the light-absorbing film 5 and is transmitted to the front through the base material 2, the front surface coating film 3, and the protective film 4. Since the illumination light is transmitted through the bright region Ra, the bright region Ra is visually recognized as bright when viewed from the front. That is, the opening portion 5a of the light-absorbing film 5 is disposed to overlap the bright region Ra as viewed from the front.

On the other hand, the dark region Rb is a region where, even when the base material 2 is illuminated from the rear, the illumination light is absorbed by the light-absorbing film 5 and thus is not transmitted. Since the illumination light is not transmitted through the dark region Rb, the dark region Rb is visually recognized as dark when viewed from the front. That is, the opening portion 5a of the light-absorbing film 5 is disposed not to overlap the dark region Rb as viewed from the front.

When the illumination light is applied from the rear to the vehicle exterior component 1 of the present embodiment, a pattern is displayed on the front surface of the vehicle exterior component 1 by the bright region Ra and the dark regions Rb. In addition, by changing the shapes of the bright region Ra and the dark region Rb, a desired pattern or character can be displayed on the front surface of the vehicle exterior component 1.

When manufacturing the vehicle exterior component 1 of the present embodiment, for example, the light-absorbing film 5 can be formed by applying paint containing a material for forming the light-absorbing film 5 to the entire rear surface 2b of the base material 2, and peeling off part of the coating film using laser light after drying. In this case, the rear surface 2b of the base material 2 can be roughened by adjusting the output of the laser light for peeling the coating film from the base material 2. That is, the roughening of the rear surface 2b can be performed at the same time as the peeling of the coating film. In this way, the roughening of part of the rear surface 2b with the laser light makes it possible to form the exposed surface 2d.

However, a step of roughening the exposed surface 2d may be performed after a step of peeling off the coating film. That is, the roughening step of the exposed surface 2d may be performed at the same time as the peeling step of the coating film or may be performed after the peeling step of the coating film.

The vehicle exterior component 1 of the present embodiment described above includes the base material 2, the front surface coating film 3, and the light-absorbing film 5. The base material 2 is formed in a plate shape and has translucency that visible light is transmitted therethrough. The front surface coating film 3 is formed to cover the front surface 2a of the base material 2 directed to the front. The light-absorbing film 5 is provided on the rear surface 2b of the base material 2 directed to the rear. In addition, the light-absorbing film 5 includes the opening portion 5a that exposes at least part of the rear surface 2b. The rear surface 2b of the base material 2 includes the adhesion surface 2c to which the light-absorbing film 5 is adhered and the exposed surface 2d exposed through the opening portion 5a. In addition, the exposed surface 2d is rougher than the adhesion surface 2c.

According to the vehicle exterior component 1 of the present embodiment, the front surface 2a of the base material 2 is covered with the front surface coating film 3. When the vehicle exterior component 1 is irradiated with sunlight, the sunlight is reflected by the front surface coating film 3, and the entire vehicle exterior component 1 is visually recognized in the color of the front surface coating film 3 from the outside.

In addition, when the vehicle exterior component 1 of the present embodiment is irradiated with illumination light, which is visible light, from the rear, the illumination light transmits through the opening portion 5a of the light-absorbing film 5 to the front. Therefore, for example, in a place where sunlight does not shine, the region where the opening portion 5a of the light-absorbing film 5 is provided is brightly visually recognized from the outside by applying the illumination light and is visually recognized as a pattern or character by a person outside.

In this case, according to the vehicle exterior component 1 of the present embodiment, since the exposed surface 2d of the rear surface 2b of the base material 2 is rougher than the adhesion surface 2c to which the light-absorbing film 5 is adhered, light transmitted through the opening portion 5a of the light-absorbing film 5 is scattered, and the brightness of a region that is visually recognized as bright can be made even. Furthermore, since the adhesion surface 2c is smoother than the exposed surface 2d, external light having entered the vehicle exterior component 1 from the outside is limited from scattering at the adhesion surface 2c and is easily absorbed by the light-absorbing film 5. Therefore, according to the vehicle exterior component 1 of the present embodiment, the boundary between the bright region (bright region Ra) and the dark region (dark region Rb) is clear, and a pattern or character displayed by the illumination light been transmitted can be more clearly visually recognized by a person outside.

In addition, the vehicle exterior component 1 of the present embodiment includes the bright region Ra and the dark region Rb. The bright region Ra is a region that is visually recognized as bright from the front when the base material 2 is irradiated with illumination light from the rear. The dark region Rb is a region that is visually recognized as dark from the front when the base material 2 is irradiated with illumination light from the rear. In addition, the opening portion 5a is disposed to overlap the bright region Ra as viewed from the front.

According to the vehicle exterior component 1 of the present embodiment, the bright region Ra can be easily formed by the opening portion 5a of the light-absorbing film 5. Therefore, it is possible to display any pattern or character by adjusting the position and shape of the opening portion 5a.

In addition, in the vehicle exterior component 1 of the present embodiment, the light-absorbing film 5 is formed of a coating film obtained by drying paint. According to the vehicle exterior component 1 of the present embodiment, the light-absorbing film 5 can be easily formed.

In addition, in the vehicle exterior component 1 of the present embodiment, the light-absorbing film 5 is black with a lower brightness than the front surface coating film 3. Therefore, when the opening portion 5a is formed, the coating film easily absorbs laser light, and the opening portion 5a can be formed even with low-power laser light.

In addition, the vehicle exterior component 1 of the present embodiment includes the transparent protective film 4 that covers the front surface coating film 3 from the front. According to the vehicle exterior component 1 of the present embodiment, it is possible to protect the front surface coating film 3 from the outside air and rainwater.

### Second Embodiment

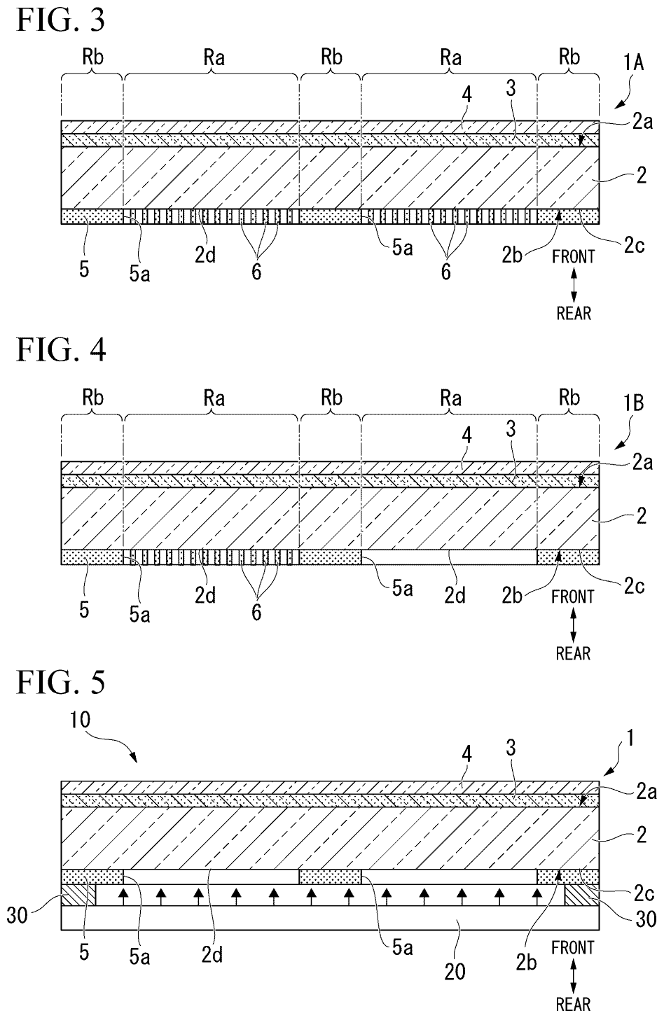

Next, a second embodiment of the present invention will be described with reference to FIG. 3. Furthermore, in the description of the present embodiment, the description of the same parts as in the first embodiment will be omitted or simplified.

FIG. 3 is a schematic cross-sectional view of a vehicle exterior component 1A of the present embodiment. FIG. 3 is a cross-sectional view at the same position as that in FIG. 2. As shown in this drawing, the vehicle exterior component 1A of the present embodiment includes an island-shaped member 6 (transmittance-adjusting member) that adjusts the transmittance of the light-absorbing film 5 in the bright region Ra (that is, the transmittance of the opening portion 5a of the light-absorbing film 5 with respect to the illumination light).

A plurality of the island-shaped members 6 are provided to be adhered to the rear surface 2b of the base material 2 and are disposed to overlap the bright region Ra as viewed from the front. In FIG. 3, each island-shaped member 6 is schematically shown in a large size, but in reality, each island-shaped member is formed to be small in a size such that a person outside the vehicle cannot identify each island-shaped member.

Each of these island-shaped members 6 absorbs part of the illumination light to be transmitted through the vehicle exterior component 1A of the present embodiment in the bright region Ra. Therefore, the transmittance of the light-absorbing film 5 in the bright region Ra is changed by the island-shaped member 6. The transmittance here means a ratio of the amount of light transmitted through the bright region Ra when the island-shaped member 6 is provided to the amount of light transmitted through the bright region Ra when the island-shaped member 6 is not provided. That is, the transmittance of the bright region Ra decreases as the shape of the island-shaped member 6 per unit area increases or the number of the island-shaped members 6 per unit area increases. As the transmittance of the bright region Ra decreases, the brightness of the bright region Ra when the illumination light is applied decreases.

As described above, the vehicle exterior component 1A of the present embodiment includes the island-shaped member 6. The island-shaped member 6 is provided on the rear surface 2b of the base material 2 in the bright region Ra and adjusts the transmittance of the light-absorbing film 5 in the bright region Ra. According to the vehicle exterior component 1A of the present embodiment, it is possible to adjust the brightness of the bright region Ra when the illumination light is applied.

The island-shaped member 6 can be formed of the same material as the light-absorbing film 5. For example, when a coating film formed of a material for forming the light-absorbing film 5 is peeled off from the base material 2 with laser light, the island-shaped member 6 can be obtained by leaving part of the coating film. For example, by setting the scanning pitch of the laser light to be greater than the diameter of the spot of the laser light, part of the coating film can be left on the base material 2. In this way, by forming the island-shaped member 6 at the same time as the light-absorbing film 5, it is not necessary to separately perform a step of forming the island-shaped member 6, and the manufacturing step of the vehicle exterior component 1A of the present embodiment can be simplified.

### Third Embodiment

Next, a third embodiment of the present invention will be described with reference to FIG. 4. FIG. 4 is a cross-sectional view at the same position as that of FIG. 2. Furthermore, in the description of the present embodiment, the description of the same parts as that of the first embodiment or the second embodiment will be omitted or simplified.

FIG. 4 is a schematic cross-sectional view of a vehicle exterior component 1B of the present embodiment. As shown in this drawing, the vehicle exterior component 1B of the present embodiment includes two bright regions Ra. One bright region Ra is provided with the island-shaped members 6, and the other bright region Ra is provided with no island-shaped member 6.

That is, the vehicle exterior component 1B of the present embodiment includes the bright regions Ra having different transmittances. According to the vehicle exterior component 1B of the present embodiment, the brightness of the bright regions Ra can be displayed in different brightness.

### Fourth Embodiment

Next, a fourth embodiment of the present invention will be described with reference to FIG. 5. FIG. 5 is a cross-sectional view at the same position as that in FIG. 2. Furthermore, in the description of the present embodiment, the description of the same parts as in the first embodiment will be omitted or simplified.

FIG. 5 is a schematic cross-sectional view of a vehicle illumination unit 10 of the present embodiment. As shown in this drawing, the vehicle illumination unit 10 of the present embodiment includes the vehicle exterior component 1 of the first embodiment, an illumination device 20, and a housing 30.

The illumination device 20 is disposed on the rear side of the vehicle exterior component 1 and applies illumination light to the vehicle exterior component 1. The housing 30 supports the vehicle exterior component 1 and the illumination device 20.

The vehicle illumination unit 10 of the present embodiment includes the vehicle exterior component 1 of the first embodiment. Therefore, it is possible for a person outside to more clearly visually recognize the pattern or character displayed on the vehicle exterior component 1 by the illumination light being transmitted.

The vehicle illumination unit 10 of the present embodiment may include the vehicle exterior component 1A of the second embodiment or the vehicle exterior component 1B of the third embodiment instead of the vehicle exterior component 1 of the first embodiment.

Hereinbefore, while appropriate embodiments of the present invention have been described with reference to the attached drawings, the present invention is not limited to the above embodiments. The shapes and combinations of the components shown in the above embodiments are mere examples, and various modifications can be made according to the design requests or the like within the scope of the present invention.

For example, in the above-described embodiments, a configuration in which the vehicle exterior component has a rectangular outer shape has been described. However, the present invention is not limited thereto. The outer shape of the vehicle exterior component may be a triangular shape or a circular shape.

In addition, the present invention can adopt the configurations described in the following appendices.

### Appendix 1

A vehicle exterior component including: a plate-shaped base material having translucency that visible light is transmitted therethrough; a front surface coating film covering a front surface of the base material directed to front; and a light-absorbing layer provided on a rear surface of the base material directed to rear and including an opening portion exposing at least part of the rear surface, in which the rear surface of the base material includes an adhesion surface to which the light-absorbing layer is adhered, and an exposed surface exposed through the opening portion, and the exposed surface is rougher than the adhesion surface.

### Appendix 2

The vehicle exterior component according to Appendix 1, including: when illumination light is applied to the base material from the rear, a dark region visually recognized from the front, and a bright region visually recognized to be brighter than the dark region from the front, in which the opening portion is disposed to overlap the bright region when viewed from the front.

### Appendix 3

The vehicle exterior component according to Appendix 2, including: a transmittance-adjusting member provided on the rear surface of the base material in the bright region and adjusting a transmittance of the light-absorbing layer in the bright region.

### Appendix 4

The vehicle exterior component according to Appendix 3, including: a plurality of the bright regions having different transmittances of the light-absorbing layer.

### Appendix 5

The vehicle exterior component according to Appendix 3 or 4, in which the transmittance-adjusting member is formed of a same material as the light-absorbing layer.

### Appendix 6

The vehicle exterior component according to any one of Appendices 1 to 5, in which the light-absorbing layer is formed of a coating film obtained by drying paint.

### Appendix 7

The vehicle exterior component according to any one of Appendices 1 to 6, in which the light-absorbing layer is black with a lower brightness than the front surface coating film.

### Appendix 8

The vehicle exterior component according to any one of Appendices 1 to 7, including: a transparent protective film covering the front surface coating film from the front.

### Appendix 9

A vehicle illumination unit including: the vehicle exterior component according to any one of Appendices 1 to 8; and an illumination device disposed on a rear side of the vehicle exterior component and configured to apply illumination light to the vehicle exterior component.

What is claimed is:

1. A vehicle exterior component comprising:
a plate-shaped base material having translucency that visible light is transmitted therethrough;
a front surface coating film covering a front surface of the base material directed to front; and
a light-absorbing layer provided on a rear surface of the base material directed to rear and including an opening portion exposing at least part of the rear surface, wherein
the rear surface of the base material includes
an adhesion surface to which the light-absorbing layer is adhered, and
an exposed surface exposed through the opening portion, and the exposed surface is rougher than the adhesion surface.

2. The vehicle exterior component according to claim 1, comprising:
when illumination light is applied to the base material from the rear, a dark region visually recognized from the front, and a bright region visually recognized to be brighter than the dark region from the front, wherein
the opening portion is disposed to overlap the bright region when viewed from the front.

3. The vehicle exterior component according to claim 2, comprising:
a transmittance-adjusting member provided on the rear surface of the base material in the bright region and adjusting a transmittance of the light-absorbing layer in the bright region.

4. The vehicle exterior component according to claim 3, comprising:
a plurality of the bright regions having different transmittances of the light-absorbing layer.

5. The vehicle exterior component according to claim 3, wherein
the transmittance-adjusting member is formed of a same material as the light-absorbing layer.

6. The vehicle exterior component according to claim 1, wherein
the light-absorbing layer is formed of a coating film obtained by drying paint.

7. The vehicle exterior component according to claim 1, wherein
the light-absorbing layer is black with a lower brightness than the front surface coating film.

8. The vehicle exterior component according to claim 1, comprising:
a transparent protective film covering the front surface coating film from the front.

9. A vehicle illumination unit comprising:
the vehicle exterior component according to claim 1; and
an illumination device disposed on a rear side of the vehicle exterior component and configured to apply illumination light to the vehicle exterior component.
